(19) United States
(12) Patent Application Publication
(10) Pub. No.: US 2016/0361903 A1
(43) Pub. Date: Dec. 15, 2016

(54) Multilayer Film Structure, Method for Making Same, and Resin Composition for Multilayer Film Structure

(71) Applicant: Eric W. Bender, Fairport, NY (US)

(72) Inventors: Eric W. Bender, Fairport, NY (US); Wayne R. Osgood, JR., Canandaigua, NY (US)

(21) Appl. No.: 14/739,869

(22) Filed: Jun. 15, 2015

(51) Int. Cl. B32B 27/08; B32B 27/18; B32B 27/32

(52) U.S. Cl. CPC B32B 27/08; B32B 27/32; B32B 27/18; B32B 2255/205; B32B 2519/00; B32B 2439/00

(57) ABSTRACT

Embodiments provide multilayer film structures, methods for making and using the same, and compositions for forming multilayer film structures, i.e., applications for the disclosed compositions. Embodiments may be remarkable in any or all of the following, example characteristics: (i) performance in a number of packaging and labeling applications; (ii) poly-lamination bonds; (iii) excellent sealing (e.g., heat or pressure-sensitive) to PE films; (iv) a receptive print surface to a broad range of inks (e.g., ordinary, metallic, UV-cured, solvent-based, water-based, etc.) that may be used in flexible or rigid packaging and labeling applications; and (v) substantially equivalent extrusion lamination bonds, sealing, and print performance to that achieved with PE skin(s), but without the manufacturing difficulties associated with co-extrusion of PE skin layers with a PP core layer. Among others, the skin layer has remarkable properties for ink bonding, PE extrusion lamination bonding, sealing to PE, and metal adhesion.

### REFERENCE TO RELATED APPLICATIONS

### FIELD

This disclosure relates to structures, compositions and methods for multilayer films. The disclosed blend of polyolefin materials, optionally including additive(s), ink(s), etc., and optionally, for example, being treated and/or metallized, exhibits, inter alia, remarkable performance in packaging and labeling applications as well as providing remarkable print surfaces.

### BACKGROUND

Coextruded, polyolefin, multilayer films, especially polypropylene-based films (i.e., those having a core including polypropylene), are widely used in packaging applications, such as pouches for dry food mixes, pet foods, snack foods, and seeds. In many film applications, it is desirable to print the film during the packaging operation in order to form the multilayer film structure. A component in coextruded, polyolefin, multilayer films may be polyethylene (“PE”) materials, such as a PE skin extruded with or coated onto a polypropylene (“PP”) core. However, PE may be problematic in manufacturing monoaxially or biaxially oriented PP films because of a tendency to stick to the die lip and/or be difficult to pin to a cast roll, and, thereby, result in depressed manufacturing efficiencies. It is desirable to have a PP-based resin that may provide remarkable performance in packaging and labeling applications as compared, for example, to print surfaces with PE skin(s).

### SUMMARY

Embodiments provide multilayer film structures, methods for making and using the same, and compositions for forming multilayer film structures, i.e., applications for the disclosed compositions. Embodiments may be remarkable in any or all of the following, example characteristics: (i) performance in a number of packaging and labeling applications; (ii) poly-lamination bonds; (iii) excellent sealing (e.g., heat or pressure-sensitive) to PE films; (iv) a receptive print surface to a broad range of inks (e.g., ordinary, metallic, UV-cured, solvent-based, water-based, combinations thereof, etc.) that may be used in flexible or rigid packaging and labeling applications; and (v) substantially equivalent extrusion lamination bonds, sealing, and print performance to that achieved with PE skin(s), but without the manufacturing difficulties associated with co-extrusion of PE skin layers with a PP core layer.

Embodiments may provide the advantages of avoiding die lip build-up that is associated with extrusion of PE skin layers. Additionally and alternatively, embodiments may provide any or all of the following, example advantages: (i) a more compatible skin polymer to the overall PP film structure than a PE skin; (ii) a surface that tracks in the orienting machine more consistently than a PE skin surface; and (iii) more uniform quenching with a PP film structure than a PE skin. The skin has remarkable fitness-for-use properties as good or better than at least medium density and high density PE skins, but also has at least equally remarkable or better fitness-for-manufacturing processing properties, and particularly so in the following areas: ink bonding; PE extrusion lamination bonding, sealing to PE, and metallization in order to provide remarkable barrier properties, e.g., oxygen and water vapor transmission rates, as well metal adhesion.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 is a schematic cross-sectional illustration of an embodiment, which includes a core layer (also called “core”) and a skin layer (also called “skin”), and is in accordance with the disclosed methods, structures, and compositions.

FIG. 2 is a tabular display of extrusion lamination bond strength results of and in accordance with the disclosed methods, structures, and compositions.

FIG. 3 is an additional tabular display of extrusion lamination bond strength results of and in accordance with the disclosed methods, structures, and compositions.

FIG. 4 is a schematic illustration of an embodiment, which includes functional skin layers and core layers that may be used in flexible packaging applications to form structures, in accordance with the disclosed methods, structures, and compositions.

FIG. 5 is a graphical display of UV-cured ink adhesion results of and in accordance with the disclosed methods, structures, and compositions.

FIG. 6 is a graphical display of solvent-based ink adhesion results of and in accordance with the disclosed methods, structures, and compositions.

FIG. 7 is a tabular display of sealing strength to a propylene-ethylene composition of and in accordance with the disclosed methods, structures, and compositions.

### DETAILED DESCRIPTION

The following is a detailed description of example embodiments accompanied by drawings. The embodiments are examples and are in such detail as to clearly communicate the claimed invention. However, the amount of detail offered is not intended to limit variations of embodiments; on the contrary, the intention is to cover all modifications, equivalents, and alternatives falling within the spirit and scope of the invention as defined by the claims. The detailed descriptions below are designed to make such embodiments obvious to a person of ordinary skill in the art.

In addition, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Generally disclosed are structures, compositions and methods for multilayer films. The disclosed blend of polyolefin materials, optionally including additive(s), ink(s), etc., and optionally being treated and/or metallized, exhibits, inter alia, remarkable performance in packaging and labeling applications as well as providing remarkable print surfaces. Reference is made to the accompanying drawings, which illustrate example embodiments.

The term “comprising” and its derivatives are not intended to exclude the presence of any additional component, step or procedure, whether or not the same is specifically disclosed. In order to avoid any doubt, any process or composition claimed through use of the term “comprising” may include any additional steps, equipment, additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or,” unless stated otherwise, refers to the listed members individually as well as in any combination.

Unless stated to the contrary, implicit from the context, or customary in the art, all parts and percentages are based on weight and all test methods are current as of the filing date of this disclosure. The contents of any referenced patent, patent application or publication are incorporated by reference in its entirety, especially with respect to the disclosure of synthetic techniques, definitions (to the extent not inconsistent with any definitions specifically provided in this disclosure), and general knowledge in the art.

As used herein, “polymer” means a compound prepared by polymerizing monomers, whether of the same or a different type. The term “polymer” as used herein generally includes, but is not limited to, homopolymers, copolymers, interpolymers, terpolymers, etc.,such as, for example, block, graft, random and alternating copolymers, terpolymers, etc. and blends and modifications thereof. As used herein, unless specified otherwise, the term “copolymer(s)” refers to polymers formed by the polymerization of at least two different monomers. For example, the term “copolymer” includes the copolymerization reaction product of propylene and an a-olefin, such as ethylene. However, the term “copolymer” is also inclusive of, for example, the copolymerization of a mixture of more than two monomers, such as, ethylene-propylene-butene.

As used herein, weight percent (“wt. %”), unless noted otherwise, means a percent by weight of a particular component based on the total weight of the mixture containing the component. For example, if a mixture or blend contains three grams of compound A and one gram of compound B, then the compound A comprises 75 wt. % of the mixture and the compound B comprises 25 wt. %. As used herein, parts per million (ppm), unless noted otherwise, means parts per million by weight.

The multilayer film of this disclosure may have a core layer, tie layer(s), skin layer(s), be treated, and/or have layers that are functional for: 1) vacuum-deposition of metals (i.e., metallized), such as with aluminum; 2) chemical-vapor deposition of metal oxides, such as aluminum or silicon oxides; or 3) combinations thereof. The core layer may contain other additives, such as inorganic fillers, pigments, regular, inks (e.g., UV-cured, antioxidants, acid scavengers, ultraviolet absorbers, processing aids such as zinc stearate, extrusion aids, slip additives, permeability modifiers, antistatic additives, and cavitating agents, such as calcium carbonate. Cavitation, on the other hand, may occur through β-nucleation that transforms the crystalline structures back to α-form during the orientation process. These additives may be introduced into the core layer in the form of master batch in a polyolefin, typically containing PP (e.g., of various densities and catalyses), before extruding or casting, and optionally orienting in the machine, transverse, or both orientations, or otherwise processing for various applications in order to form various structures, such as those disclosed herein.

Numerical ranges referenced herein include all values from and including the lower and the upper values, in increments of one unit, provided that there is a separation of at least two units between any lower value and any higher value. As an example, if a compositional, physical or other property or process parameter, such as, for example, lamination bond strength is from 100 to 1,000, it is intended that all individual values, such as 100, 101, 102, etc., and sub ranges, such as 100 to 144, 155 to 170, 197 to 200, etc., are expressly enumerated. For ranges containing values that are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure.

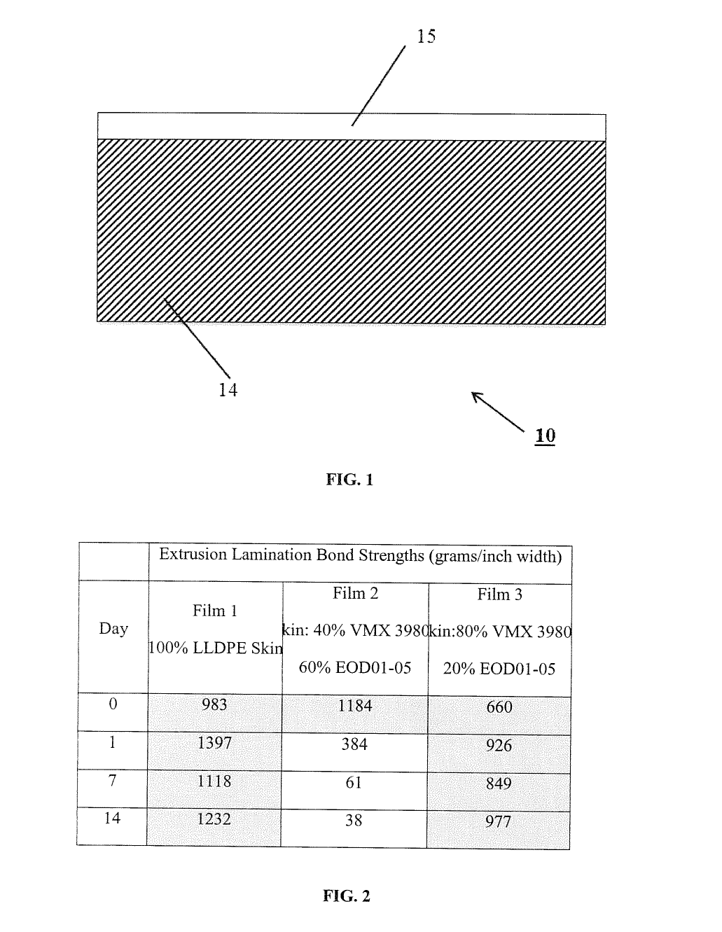

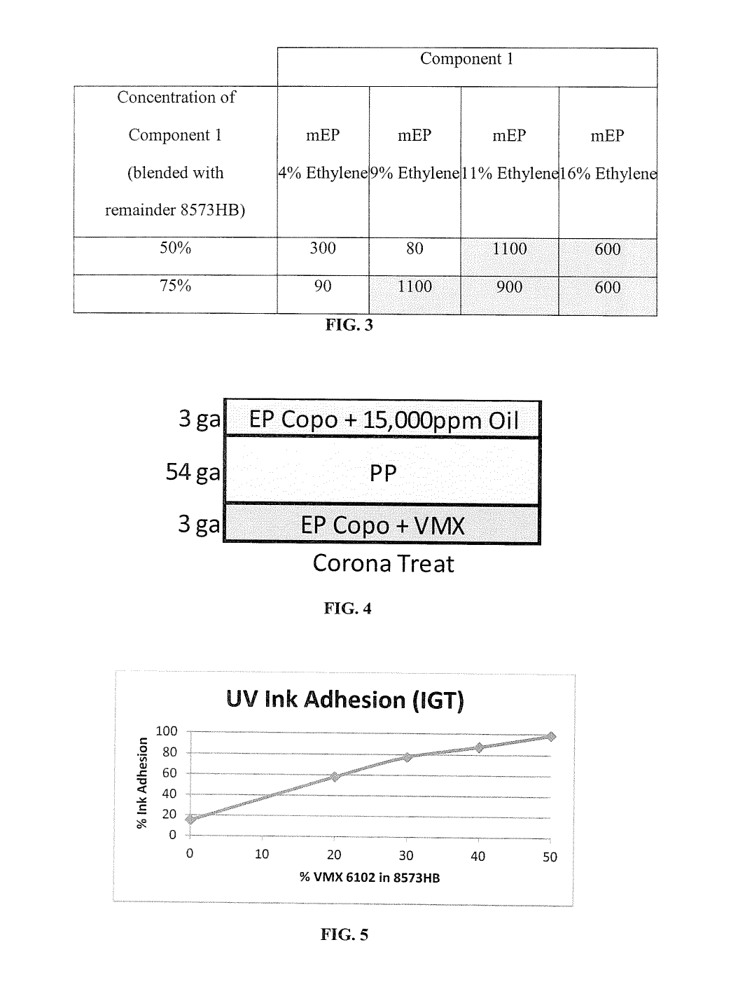

For the purposes of this disclosure, conventional or standard methods and conditions used to measure or describe properties are those which are understood by one of skill in the art from the context of the disclosure, or stated herein, and include, without limitation, the following:
(a) Bond lamination strength and failure mechanisms may be determined, for example, according to ASTM Standard D1876. The method was practiced by backing both sides of the lamination with 610-tape and cutting the sample to 1″ width and pulling on a tensile tester at 12″/min or other suitable procedure.
(b) A narrow web pilot extrusion laminator was used to produce extrusion laminations tested to provide data for FIGS. 2 and 3. 895 PE film was laminated to the experimental film structure using 9 pounds per ream of Marlex 1017 PE, with the novel film surface in contact with the polyethylene. The PE extrudate was extruded at 630° F. with a 5.5″ air gap centered above the two films being laminated. During the lamination process, a flag was put in between the experimental film surface and the PE in order to test bong strength at that interface. Bond strength was measured on an Instron® tensile tester at different time periods following lamination. In instances when the bond strength was below 500 g/in (outside the design window of the invention), the measured bond strength was a true value of the strength between the poly and the film surface. In other instances, when the bond strength was measured to be >500 g/in, the failure mode was polystretch or polytear, meaning that the strength of the bond between the experimental film surface was greater than the strength of the poly or overall film substrate, causing them to stretch and/or tear. In these instances, while a bond strength is listed, the true bond strength between the experimental film surface and the poly was higher, meaning the bonds are adequate for the applications of the film. Heat seal to PE may be determined, for example, according to ASTM Standard F88.
(c) Samples were crimp sealed with the skin side to Appleton 1.5 mil 895LQ on the untreated side at 200° F./60 psi/0.75 s dwell and pulled using a T-peel on the tensile tester.
(d) Print anchorage may be determined using Tappi Standard Test Method FTM21. 3M 610 tape was used with immediate pull repeating 3× on the same print area for the conventional ink adhesion. The printed ink area was scored with knives in a crosshatch pattern for UV print tests and tested with 3M 600, 610, and 810 tapes.
(e) For the conventional ink anchorage test, a Chesnut narrow web press was used to apply three layers of solvent-based inks, one on top of the other onto the experimental film surface. The first layer of ink was Sun K81 Red and was applied roto-gravure with a 360-quad gravure roll. The second layer of ink, applied flexographically, was Sun K81 Red and was applied with a 360-quad anilox roll. The third layer of ink, applied flexographically, was Sun K81 White and was applied using a 220-quad anilox roll. This method is useful for predicting offline ink adhesion on many of today's high-speed flexographic printing presses, which operate at speeds greater than 1200 fpm and up to 2500 fpm.
(f) An IGT F1 Printability Tester was used with a 3 BCMI anilox roll to apply UV Flexo Gemini ink onto the experimental film surface. The ink was cured using a Model F300 Fusion UV Unit at 30 m/min and 0.105 J/cm² power.

“Composition” and like terms, as used herein, mean a mixture of two or more materials. The term “composition” does not imply or require the occurrence, or non-occurrence, of any chemical reaction, whether during mixing, blending, extrusion, casting, orienting, coating, treating, or otherwise. It will be understood that specifically referenced and described herein are “compositions for multilayer films,” or layers thereof, and that this terminology is intended to identify and disclose compositions from which may be formed corresponding multilayer films by processing under specified and/or known conditions, or, in and on specified and/or known equipment, such as equipment for extrusion and orienting.

As used herein, the term “extrusion” is intended to include extrusion, co-extrusion, blown extrusion, extrusion coating, or combinations thereof, whether by tubular methods, planar methods, or combinations thereof as may be utilized to produce multilayer films.

As used herein, the term “oriented” material is defined herein as a material, multilayer film, or layer thereof, which has been formed by extrusion, and, thereafter, has been oriented by use of an orienting apparatus to stretch the subject material below the melting point (MP) thereof, in at least one orienting direction. For example, extruded film may be uniaxially oriented by being stretched in one direction, such as machine direction (“MD”) or transverse direction (“TD”). Also for example, extruded film may be biaxially oriented by use of a tenter apparatus operated to stretch the extruded material in a machine direction (“MD”) and in a transverse direction (“TD”). It will be understood that “oriented” material includes, at least, uniaxially oriented and biaxially oriented multilayer films. It will be further understood that according to embodiments herein disclosed, multilayer films having one or more voided layers may be formed by orientation, such as for example by suitable biaxial orientation, of an extruded multilayer film, including a void layer having therein a suitable voiding agent or cavitating agent, so as to stress the polymer matrix of the void layer and thus form a voided layer having therein a large number of voids. It will be understood that the voids refract light and thus create opacity of the voided layer.

Unless specifically set forth and defined or otherwise limited, “elastomers” refer to copolymers of either propylene or ethylene with lower crystallinity, lower modulus of elasticity, lower melting temperatures, and lower density relative to semi-crystalline polymers of polypropylene or polyethylene.

As used herein, the term “polyethylene” as used herein refers to families of resins commonly identified as PE and obtained, generally, by substantial polymerization of ethylene, C₂H₄.

The term “polypropylene” as used herein, is a type of polyolefin that may be employed in the film of the present invention, and refers to families of resins obtained by substantially polymerizing the gas propylene, C₃H₆.

The term “antiblocking material” means a material used to prevent or reduce adhesion between film layers during manufacture, and in roll form. Antiblocking materials may include, for example, poly (methyl methacrylate) or “PMMA.”

The term “propylene-based polymer,” as used herein, refers to a polymer that comprises a majority weight percent polymerized propylene monomer (based on the total weight of polymerizable monomers), and optionally may comprise at least one or more polymerized comonomer(s), such as ethylene. The propylene-based polymer may be a propylene homopolymer or a copolymer (including copolymers with three or more co-monomers).

The term “ethylene-propylene copolymer,” as used herein, refers to a polymer that comprises polymer units derived from propylene monomers, polymer units derived from ethylene monomers. In a propylene/ethylene copolymer, either the polymerized propylene monomers or the polymerized ethylene monomers constitute a majority weight percent of the polymer.

The term “metallocene catalyzed propylene-ethylene copolymers” means a propylene-ethylene copolymer wherein polymerization of the propylene monomers or ethylene monomers has been accomplished in the presence of metallocene catalyst, such as, for example, hafnium (Hf) or other Group IV metal.

The term “cavitating agent” means void-initiating particles added to one or more layers (“voided layer”) of a multilayer film for creating a substantially opaque layer by stressing the polymer matrix of the voided layer to form a large number of voids therein. Suitable cavitating agents may include any suitable organic or inorganic material that is incompatible with the polymer material(s) contained in the layer(s) to which the cavitating agent is added, at the temperature of biaxial orientation. Examples of suitable void initiating particles may include, but are not limited to, PMMA, zeolite, calcium carbonate (CaC0₃), polybutylene terephthalate (“PBT), nylon, cyclic-olefin copolymers, solid or hollow pre-formed glass spheres, ceramic spheres, talc, chalk, and combinations thereof. In some embodiments, the average diameter of the void-initiating particles may range from about 0.1 micron to 20 microns. The particles may be of any desired shape such as, for example, substantially spherical. Alternatively, as used herein, “cavitating agent” may include β-crystals of polypropylene that are converted to α-crystals during orientation and leaving respective voids in the layer.

The “ethylene content” is the percent by weight (wt. %) of ethylene in a referenced structure or composition. Ethylene content values of the component resins were obtained from the suppliers. Ethylene content of a composition for making a multilayer film structure, or for making a layer thereof, may be determined by calculation, for example, if a layer is essentially comprised of 40% of a metallocene-catalyzed EP copolymer of 11% ethylene content and 60% of an EP copolymer of 3.5% ethylene content, then the calculated ethylene content of the layer would be 6.5% (that is, 0.4*0.11 contribution from the m-EP copolymer plus 0.6*0.035 contribution from the EP copolymer).

Illustrated in FIG. 1 is a diagrammatic view of an embodiment of a polyolefin multilayer film structure (10) usable within the scope of the disclosure. Multilayer film structure (10) includes a core layer (14) and a skin layer (15) adjacent thereto. Core layer (10) has as a primary component comprising one or more thermoplastic polymers.

In other various embodiments, the core layer primary component may include different amounts of polypropylene, alone or in combination with other compositions. A suitable commercially polypropylene product is PP4712, which is available from ExxonMobil Corporation.

The skin layer (15) is formed of a co-extrudate called a skin layer composition. The skin layer composition includes a first component, which, for example, may be elastomers, metallocene catalyzed propylene-ethylene copolymers, and combinations of the foregoing. A suitable, commercially available, first component is Vistamaxx® VMX 6102, available from ExxonMobil Corporation.

In addition to the first component, the skin layer composition may include a second component, which may be ethylene-propylene copolymers, ethylene-propylene-butylene terpolymers, propylene-butylene copolymers, propylene homopolymers, and combinations of the foregoing. A suitable, commercially available, second component is Total 8573HB available from Total Petrochemical and Refining USA, Houston, Tex.

In addition to the first and second components, the skin layer composition may include a third component, which may be one or more antiblocking materials. For example, the antiblocking material may be poly(methyl methacrylate) (PMMA) in a concentration of about 2000 ppm. A suitable, commercially available, third component is Epostar MA1004 (4 μm PMMA) available from Nagase & Co. Ltd, Tokyo, Japan.

The skin layer composition also may include a fourth component, which may be one or more slip additive materials, such as polydimethylsiloxane (PDMS or silicone oil) in a concentration of about 15,000 ppm in an embodiment. A suitable, commercially available, fourth component is Xiameter PMX-200 60,000 cSt, available from Dow Corning Corporation, Midland, Mich.

In an embodiment, the skin layer composition also may include one or more additives or agents, such as, for example, fillers, anti-static agents, opacifying agents, UV inhibitors, inks, whether ordinary, UV-cured, solvent-based, water-based (i.e., a subset of solvent-based), metallic or otherwise.

In an embodiment, the skin layer composition may include from about 20% to about 80% of the first component, and the skin layer composition in remainder may include primarily the second component. The first component may be primarily metallocene catalyzed propylene-ethylene copolymers, and the skin layer composition in remainder may include primarily the second component

In an embodiment, the skin layer composition may have an ethylene concentration by weight at or exceeding 4.5% of the skin layer composition. In one embodiment, the ethylene concentration by weight, which is at or exceeds 4.5% of the skin layer composition, may include a fraction contributed from a first component, which is primarily metallocene catalyzed propylene-ethylene copolymer(s).

The above-described, multilayer films, whether viewed as compositions or those used in applications to make structures, may be extrusion-laminated or extrusion-coated in order to add additional layers with additional functionality to the multilayer films. For example, a metallized, high-barrier film may be laminated to a multilayer film using a PE extrudate; in this operation, two webs are laminated together by bringing them together at a nip point while dropping extruded, molten polymer between them. The molten polymer (i.e., extrudate) is chilled, and a bond is formed between the extrudate and the multilayer film. Variations of PE and its copolymers may be used as the extrudates. PE skins provide very strong bonds because the PE's in the extrudate and in the skin are miscible in the molten phase, and, therefore, form a “welded” interface. Typical bond strengths from such an operation may be 500 g/in or higher; additionally, the bond strength may be expected to increase to greater than 1000 g/in when exposed to additional high heat, such as that experienced in heat-sealing, wherein the mode of bond failure would be destruction of the structure because the extrudate would be welded to the skin of the film structure. It is noteworthy that the skins provided herein provide for remarkable metal adhesion, i.e., metal bonds, which, in turn, provide for remarkable oxygen and water-vapor transmission rates, important barrier properties for applications of the disclosed multilayer films disclosed to form structures, e.g., packages, bags, containers, labels, etc. (collectively, “packaging and labeling”).

In another embodiment, the multilayer film structure (10), when tested for lamination bond strength, may be characterized by a substantial absence of bond peel at an interface between the skin layer (15) and the extrudate. In another embodiment, the lamination may be further characterized by polystretch failure, polytear failure, and combinations thereof. In yet another embodiment, the multilayer film structure (10) may be further characterized by a lamination bond strength of at least about 500 grams per inch. In yet another embodiment, the multilayer film structure (10) may be further characterized by a lamination bond strength that increases to greater than 1000 grams per inch when subjected to additional high heat, as when heat-sealed.

In an embodiment, multilayer film structure (10) may be characterized by skin layer (15), which is able to achieve about 100% adhesion (i.e., “complete”) with typical solvent-based inks, as well as complete or nearly complete adhesion at high press speeds with high coverage. This skin layer (15) may achieve this nearly 100% adhesion of, for example, solvent-based ink after being corona-treated, as compared to other films which might require flame treatment to achieve similar print performance. The treated skin may additionally and alternatively occur via corona discharge treatment, plasma treatment, or otherwise.

In yet another embodiment, the skin layer composition may include a first component comprising from about 20% to about 60% of metallocene catalyzed propylene-ethylene copolymers which is, for example, Vistamaxx® VMX 6102.

The skin layer composition may include, in remainder, a second component, which is from about 80% to about 40% of EP copolymer which is, for example, Total 8573HB. In addition, the skin layer composition may include antiblock material which is about 2000 ppm of PMMA, such as Epostar MA1004. The skin layer may be corona-treated, flame-treated, plasma-treated, or otherwise to chemically react oxygen to the surface and to increase the surface energy. A skin layer composition according to this embodiment exhibits good adhesion of ink to the skin layer (at high press speeds) for improved print performance.

FIG. 2 is a tabular display that shows extrusion lamination bond strengths of three, multilayer films, each having different skin layers that were tested over 14 days. FIG. 2 illustrates that Film 3, which has a skin comprising 80% VMX 3980, provides comparable performance to Film 3, which has a skin comprising 100% LLDPE. Notably particular is that the extrusion lamination bond strength does not decay over time. In FIG. 2, the PE lamination extrudate is Chevron Marlex 1017 LDPE, which is made available by Chevron Phillips. In the example, the skin layer is extruded from a respective skin layer resin composition that includes 80% by weight of a first component consisting of metallocene-catalyzed propylene-ethylene copolymers, such as ExxonMobil Vistamaxx® VMX 3980 from ExxonMobil Chemical Corporation. In the example, the skin layer is extruded from a respective skin layer composition that includes 20% by weight of a second component, which may be propylene-ethylene copolymers, such as Total 8573HB from Total Petrochemicals and Refining USA, Inc., located in Houston, Tex. In the example, the skin layer is extruded from a respective skin layer composition that includes a third component, which may be antiblock material(s), such as 2000 ppm of Echostar MA1004 (4 μm PMMA) from Nagase and Co. Ltd.

In FIG. 2, the multilayer film having a composition includes 80% Vistamaxx VMX 3980 as the first component, about 20% Total EOD01-05 as the second component, and 2000 ppm Echostar MA 1004 as the third component, exhibits extrusion lamination bond strength (g/in) of 660 g/in. at day 0 that increases to 977 /g/in at day 14. In FIG. 2, the embodiment of a multilayer film structure wherein a composition includes 40% Vistamaxx® VMX 3980 as the first component, about 60% Total EOD01-05 as the second component, and 2000 ppm Echostar MA 1004 as the third component, exhibits extrusion lamination bond strength (g/in) that decreases from 1184 g/in at day 0 to only 38 g/in at day 14. For comparison, a sample having a core layer of PP and a skin layer formed of 100% LLDPE is shown in FIG. 2, and has a lamination bond strength of 983 g/in on day 0, which stays in the same range through day 14, and, specifically, ends at 1232 g/in on day 14. Note that the examples within FIG. 2 that are reported with a comparatively darker background experienced polystretch and/or polytear, which represents a bond that does not fail at the interface between the film surface and the extrudate. In FIG. 2, the blend with 80% VMX 3980 has remarkable extrusion lamination bond strength, whereas the blend with 40% VMX 3980 does not have sufficient bond strength after 1-14 days.

FIG. 3 shows provides results from additional samples that demonstrate the link between extrusion lamination bond strength and the overall ethylene content of the skin layer, which includes two components. This table displays aspects of example embodiments of a multilayer film having a core layer and skin layer. The core layer includes an extruded PP. As shown in FIG. 3, embodiments may include a skin layer having at least a first component as described below, and, in remainder, a second component consisting of ethylene-propylene (“EP”) copolymer, i.e., Total 8573HB, which is made available by Total Petrochemical and Refining USA, Houston, Tex. In the first through fourth samples shown in the first row, the skin layer includes 50% by weight of the second component, which was metallocene-catalyzed, random copolymer of propylene having 4% ethylene content, i.e., Total EOD01-05, which is made available by Total Petrochemical and Refining USA, Houston Tex. The first sample included a first component, which was a metallocene-catalyzed, random copolymer of propylene, respectively having 4%, 9%, 11%, and 16% of ethylene content, respectively. The 4% EP copolymer used was Total 8573HB, which is made available by Total Petrochemical and Refining USA, Houston Tex.; the 9%, 11%, and 16% embodiments used the same EP copolymer, Vistamaxx® VMX 3980, VMX 3020, and VMX 6102, respectively, which are made available by ExxonMobil Chemical Company, Houston Tex.

In the fifth through eighth samples shown in the second row, the skin layer includes 75% by weight of the second component, which was metallocene-catalyzed, random copolymer of propylene having 4% ethylene content, i.e., Total EOD01-05. The fifth sample included a first component, which was a metallocene-catalyzed, random copolymer of propylene, respectively having 4%, 9%, 11%, and 16% of ethylene content, respectively. The 4% EP copolymer used was Total 8573HB, and the 9%, 11%, and 16% embodiments used the same EP copolymer, Vistamaxx® VMX 3980, VMX 3020, and VMX 6102, respectively.

The values displayed in FIG. 3 are for extrusion lamination bond strength, and, as in the FIG. 2, are expressed in g/in. Each of the examples within FIG. 3 that are reported with a comparatively darker background experienced material failure, i.e., failure at the interface between the skin layer and the extrudate, wherein the failure is polystretch failure, polytear failure, or both, in the absence of lamination bond.

FIG. 4 is a schematic layer diagram of a test sample of an exemplary multilayer film that is roughly 60-gauge. The core layer, approximately 54 gauge in this example embodiment, includes PP, wherein the type(s) may vary, for instance, in density, stereoregularity, catalysis, and so forth. With particular attention drawn to the lower skin layer, its composition may include a first component comprising EP copolymer(s), produced via metallocene-catalysis or otherwise, and a second component comprising PP-based elastomer(s), such as Vistamaxx® (i.e., “VMX”) composition(s) made available from ExxonMobil Chemical Corporation. This lower skin layer may be corona-treated or treated otherwise. The upper skin layer of this exemplary multilayer film may be formed from EP copolymer(s) and slip material, e.g., oil; thus, the upper skin layer lacks a component that consists of PP-based elastomer(s).

FIG. 5 is a graphic display showing UV-cured ink adhesion for exemplary films having a general design as shown by FIG. 1. UV-cured ink adhesion was tested for film produced with different concentrations of Vistamaxx® VMX 6102 in Total 8573HB. To test UV-cured ink adhesion, films were re-treated on the skin, and UV-cured ink was applied using an IGT. Ink adhesion data graphed in FIG. 5 shows that as the level of Vistamaxx® increases in the skin, the UV-cured ink adhesion increases.

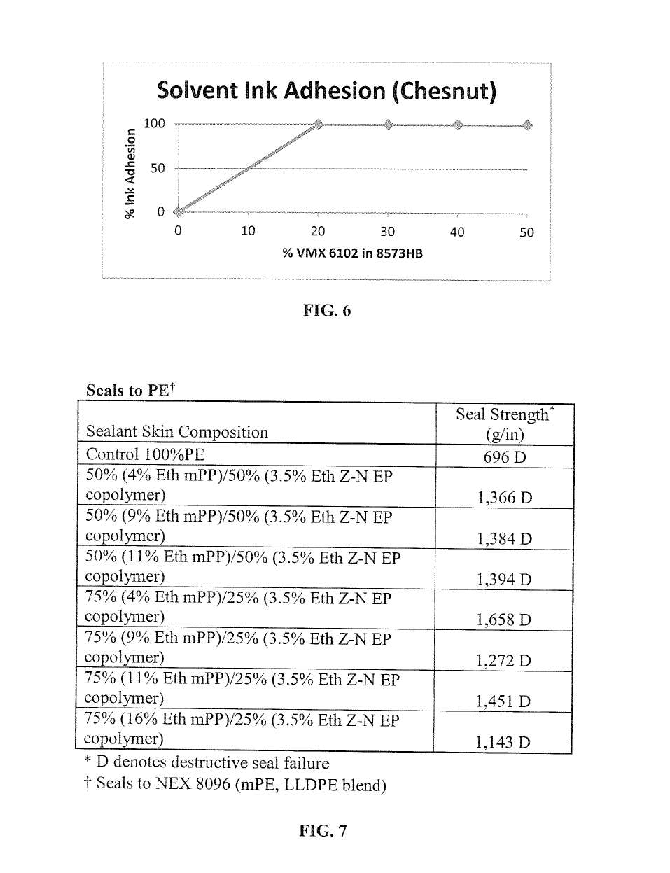

FIG. 6 is a graphic display showing solvent-based ink adhesion for exemplary films, having a general design as shown by FIG. 1, using a Chesnut® narrow web press. Film was printed using a first layer of Sun K81 red ink (360Q gravure roll), a second layer of Sun K81 red ink (360Q anilox roll), and a third layer of Sun K81 White Ink (220Q anilox roll), wherein all three of these inks are made available by The Sun Ink Corp., Hummelstown, Pa. Ink adhesion was tested using three pulls of 610-tape in the triple trap area. There was 0% ink adhesion on the print surface with 100% corona-treated Total 8573HB in the skin. There was 100% ink adhesion on the print surface with 20-50% Vistamaxx® in the skin.

Turning now to FIG. 7, this table provides results for a film of the general design illustrated at FIG. 1. FIG. 7 shows different seal strengths (e.g., heat seal strengths) to PE for skin layer compositions, wherein the “control” contains no PP, and the remaining seven, experimental skin layers contain a first set of 50% PE and a second set of 75% PE, but the 50% and 75% PE has an incremental increase in ethylene content. Additionally, these seven, experimental skin layers also include the first set having 50% and the second set having 25% of a fixed 3.5% ethylene content from a Ziegler-Natta catalyzed EP copolymer. As compared to the control, all of the experimental films had seal strength failures that were roughly twice as that of the control, to thereby evidence such a film having a much stronger sealing to PE when the film's skin included ethylene.

Embodiments provide improved multilayer film structures, methods for making and using the same, and compositions for multilayer film structures. Embodiments are characterized by remarkable performance in a number of packaging and labeling applications, poly-lamination bond strengths, and sealing to PE film. Embodiments may provide heat sealing to PE film that is the equivalent of what may be achieved with a PE skin layer, but without the manufacturing difficulties associated with co-extrusion of PE skin layers with a PP core layer. Embodiments may provide the advantages of avoiding die lip build-up that is associated with extrusion of PE skin layers, and, additionally and alternatively, provide a print surface with print anchorage superior to other skin layers and superior to skin layers formed of other compositions, including those used in skin layers of MOPP or BOPP films. Embodiments may provide compositions for making multilayer film structures having skin layers with multiple advantages in manufacturing and converting.

Although specific embodiments are illustrated and described herein, it will be appreciated by those of ordinary skill in the art that certain variations may be made from the specific embodiments described herein without departing from the scope of this disclosure. This application is intended to cover any adaptations or variations. For example, although described in terms of the specific embodiments, one of ordinary skill in the art will appreciate that implementations may be made in different embodiments to provide the required functions. One of skill in the art will appreciate that names and terminology used herein are not intended to limit embodiments. Additional subject matter may be added to correspond with future enhancements without departing from the scope of embodiments and this disclosure.

What is claimed is:

1. A polyolefin multilayer film comprising:
a core layer having a primary component comprising one or more thermoplastic polymers; and
a skin layer located adjacent to the core layer, the skin layer comprising an extrudate having a first component and a second component, wherein
the first component is selected from at least one member of a first group consisting of elastomers, ethylene-propylene copolymers, and combinations thereof, and
the second component selected from at least one member of a second group consisting of ethylene-propylene copolymers, propylene-ethylene-butylene terpolymers, propylene-butene copolymers, propylene homopolymers, and combinations thereof.

2. The polyolefin multilayer film of claim 1, further comprising the skin layer having another component comprising one or more antiblocking materials.

3. The polyolefin multilayer film of claim 1, further comprising the skin layer having another component comprising one or more slip additive materials.

4. The polyolefin multilayer film of claim 1, wherein the thermoplastic polymers comprise polypropylene, polypropylene-based copolymers, or combinations thereof.

5. The polyolefin multilayer film of claim 1, wherein the first component is within a range from about 20 wt % to about 80 wt %, and primarily the second component in remainder.

6. The polyolefin multilayer film of claim 1, wherein the first component is within a range from about 40 wt % to about 80 wt %, and primarily the second component in remainder.

7. The polyolefin multilayer film of claim 1, wherein the skin layer has an ethylene concentration at or exceeding 4.5 wt % of the skin layer.

8. The polyolefin multilayer film of claim 1, wherein the skin layer has a fraction of an ethylene concentration contributed from the first component.

9. The polyolefin multilayer film of claim 1, wherein the skin layer undergoes metallization, chemical-vapor deposition, or combinations thereof.

10. The polyolefin multilayer film of claim 1, wherein the skin layer adheres to metal.

11. The polyolefin multilayer film of claim 1, wherein the skin layer provides fitness-for-use and fitness-for-manufacturing properties that are at least equal to one or more skins.

12. The polyolefin multilayer film of claim 1, having an extrusion lamination bond strength of at least about 500 grams per inch.

13. The polyolefin multilayer film of claim 1, wherein the skin layer is a treated skin layer.

14. The polyolefin multilayer film of claim 1, wherein the skin layer adheres to inks at high press speeds with high coverage, wherein the inks comprise metallic inks, UV-cured inks, solvent-based inks, water-based inks, or combinations thereof.

15. The polyolefin multilayer film of claim 1, wherein adhesion of inks to the skin layer generally increases through at least nearly complete adhesion as a weight percentage of ethylene increases in the skin layer.

16. The polyolefin multilayer film of claim 1, wherein a seal strength of the skin layer to a propylene-ethylene composition is at least 1.5 times greater when the skin layer comprises at least a fractional portion of ethylene.

17. The polyolefin multilayer film of claim 1, further comprising one or more tie layers, additional skin layers, or both.

18. The polyolefin multilayer film of claim 1, wherein the core layer is cavitated.

19. A method comprising: receiving the multilayer film of claim 1; and forming a package, tag, label, pouch or container from the multilayer film.

20. (canceled)

21. The polyolefin multilayer film of claim 1, wherein the skin layer comprises an ethylene copolymer, and the polyolefin multilayer film has a heat seal failure to polyethylene with a strength of at least 1100 g/in (433 g/cm).

22. The polyolefin multilayer film of claim 1, wherein the polyolefin multilayer film has a heat seal strength failure to polyethylene at least 1.8 times greater when the skin layer comprises polypropylene in addition to polyethylene.
